(19) United States
(12) Patent Application Publication
(10) Pub. No.: US 2013/0062115 A1
(43) Pub. Date: Mar. 14, 2013

(54) OUTDOOR CONTROL CABLE

(71) Applicant: Wan-Yu Chang, New Taipei City (TW)

(72) Inventor: Wan-Yu Chang, New Taipei City (TW)

(21) Appl. No.: 13/227,712

(22) Filed: Sep. 8, 2011

(51) Int. Cl. H02G 15/00

(52) U.S. Cl. 174/74 R

(57) ABSTRACT

An outdoor control cable includes a cable, a ground terminal, other terminals, and a connector. The cable includes an insulating coating, power lines enclosed by an insulating layer, signal lines enclosed by the insulating layer, and a metal shield. The power lines and the signal lines are enclosed by the insulating coating. The signal lines are further enclosed by the metal shield. The ground terminal is electrically connected to the metal shield. The other terminals are electrically connected to the power lines and the signal lines. The connector includes a casing, a jack, and the ground terminal and other terminals which are protruded and exposed from the jack. Hence, the outdoor control cable has both power lines and signal lines. The metal shield blocks electromagnetic interference from the power lines.

The ground terminal is electrically connected to the metal shield and thereby grounds and guides the electromagnetic interference to earth.

### BACKGROUND OF THE INVENTION

1. Field of the Invention

The present invention relates to outdoor control cables, and more particularly, to a control cable connected to various power generating devices outdoors.

2. Description of the Prior Art

With green awareness being increasingly high, a wide variety of power generating devices have gone green. For example, power generating devices which provide people with electric power generated by a natural means, such as sunlight or wind.

Electric power generated from the aforesaid power generating devices is delivered with an outdoor control cable. A conventional outdoor control cable is installed outdoors and thus has to be coated with an insulating layer made of any material other than metal. The only thing inside the insulating layer is a power line for transmitting power. To transmit control signals, it is necessary to install a control IC at each of the two ends of the outdoor control cable; and, doing so incurs costs, not to mention that the control IC thus installed is likely to fail and rot.

### BRIEF SUMMARY OF THE INVENTION

In view of this, it is imperative to provide an outdoor control cable comprising a power line and a signal line, with the power line imposing no interference on the signal line.

Hence, the present invention provides an outdoor control cable that comprises a cable, a ground terminal, a plurality of other terminals, and a connector. The cable comprises an insulating coating, a plurality of power lines each enclosed by an insulating layer, a plurality of signal lines each enclosed by the insulating layer, and a metal shield. The power lines and the signal lines are enclosed by the insulating coating. The signal lines are further enclosed by the metal shield. The ground terminal is electrically connected to the metal shield. The other terminals are each electrically connected to the power lines and the signal lines, respectively. The connector comprises a casing, a jack, and the ground terminal and plurality of other terminals which are protruded and exposed from the jack.

The present invention further provides an outdoor control cable that comprises a cable, a ground terminal, a plurality of other terminals, and a connector. The cable comprises an insulating coating, a plurality of power lines each enclosed by an insulating layer, a plurality of signal lines each enclosed by the insulating layer, a metal shield, and a ground bare wire. The power lines, the signal lines, and the ground bare wire are enclosed by the insulating coating. The signal lines and the ground bare wire are further enclosed by the metal shield. The ground bare wire is in electrical contact with the metal shield. The ground terminal is electrically connected to the ground bare wire. The other terminals are each electrically connected to the power lines and the signal lines, respectively. The connector comprises a casing, a jack, and the ground terminal and plurality of other terminals which are protruded and exposed from the jack.

Accordingly, the aforesaid two outdoor control cables each comprise power lines and signal lines concurrently and thereby transmit power and signals, respectively, thereby dispensing with a conventional control IC and thus cutting costs. Furthermore, the metal shield blocks electromagnetic interference from the power lines. In particular, the ground terminal is directly electrically connected to the metal shield. Or, alternatively, the ground terminal is in indirect electrical contact with the metal shield via the ground bare wire, such that the electromagnetic interference is grounded and guided to the earth.

### BRIEF DESCRIPTION OF THE SEVERAL VIEWS OF THE DRAWINGS

FIG. 1 is a perspective view of the present invention;

FIG. 2 is a partial enlarged view of the first embodiment of the present invention;

FIG. 3 is a cross-sectional view of the first embodiment of the present invention;

FIG. 4 is a partial enlarged view of the second embodiment of the present invention;

FIG. 5 is a cross-sectional view of the second embodiment of the present invention; and

FIG. 6 is a full perspective view of the present invention.

### DETAILED DESCRIPTION OF THE EMBODIMENTS OF THE INVENTION

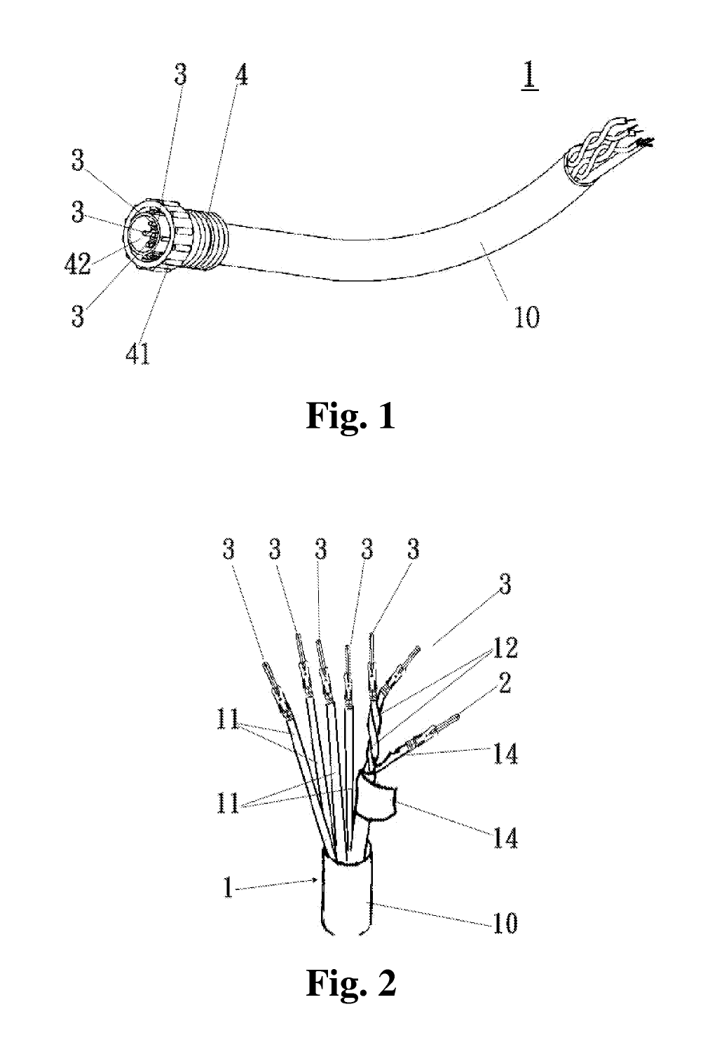

The present invention provides an outdoor control cable for transmitting power generated from a power generating device. The outdoor control cable of the present invention is embodied in two embodiments. FIGS. 1, 2, 3 illustrate the first embodiment. FIGS. 1, 4, 5 illustrate the second embodiment.

Referring to FIGS. 1, 2, 3, the outdoor control cable in the first embodiment comprises a cable 1, a ground terminal 2, a plurality of other terminals 3, and a connector 4.

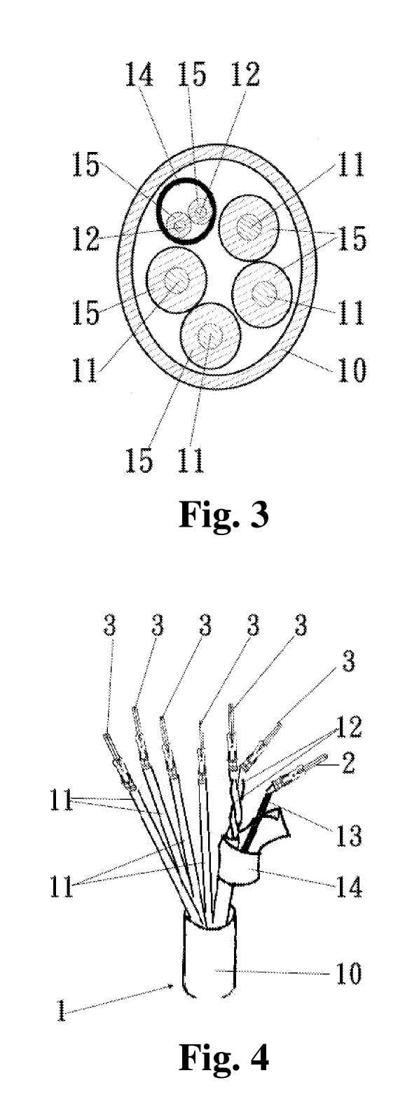

The cable 1 comprises an insulating coating 10, a plurality of power lines 11 each enclosed by an insulating layer 15, a plurality of signal lines 12 each enclosed by the insulating layer 15, and a metal shield 14. The power lines 11 and the signal lines 12 are enclosed by the insulating coating 10. The signal lines 12 are further enclosed by the metal shield 14. As shown in FIG. 3, the metal shield 14 blocks electromagnetic interference from the power lines 11. The interference between the signal lines 12 arranged in pairs can be further reduced for certain, if the signal lines 12 are twisted to form twisted-pair signal lines. The power lines 11 transmit power. The signal lines 12 transmit signals. The metal shield 14 is an aluminum foil element.

The ground terminal 2 is electrically connected to the metal shield 14, such that the ground terminal 2 grounds electromagnetic interference and guides it to the earth. The other terminals 3 areelectrically connected to the power lines 11 and the signal lines 12, respectively.

The connector 4 comprises a casing 41 made of plastics, a jack 42, and the ground terminal 2 and plurality of other terminals 3 which are protruded and exposed from the jack 42.

Referring to FIGS. 1, 4, 5, the outdoor control cable in the second embodiment comprises a cable 1, a ground terminal 2, a plurality of other terminals 3, and a connector 4.

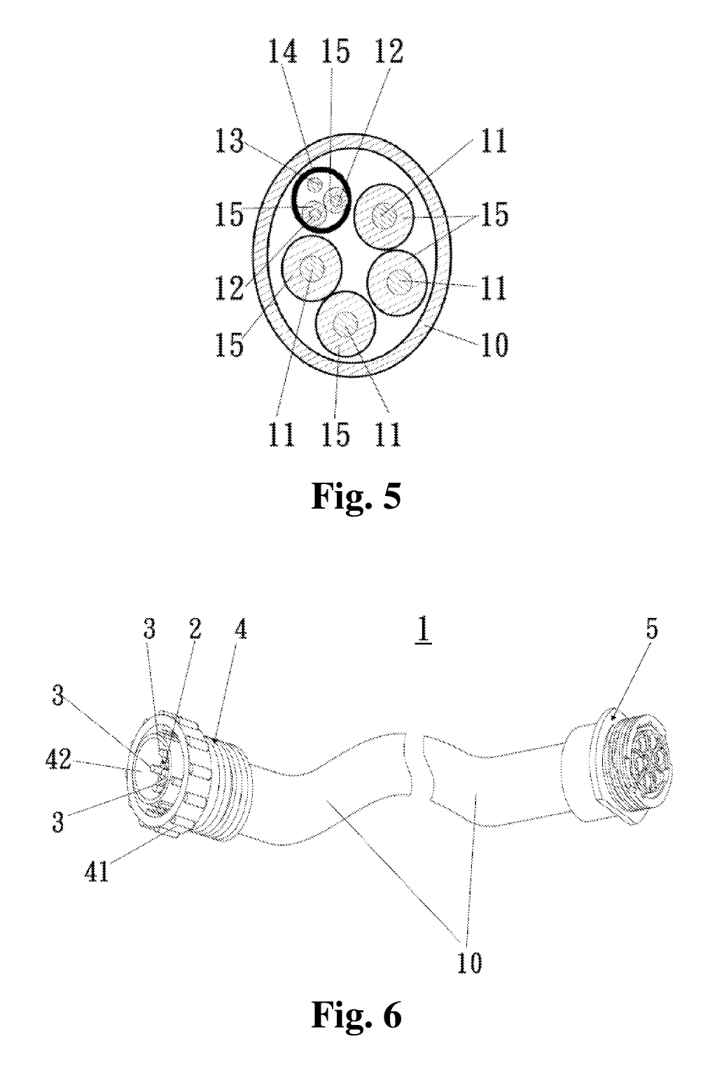

The cable 1 comprises an insulating coating 10, a plurality of power lines 11 each enclosed by the insulating layer 15, a plurality of signal lines 12 each enclosed by the insulating layer 15, a metal shield 14, and a ground bare wire 13. The power lines 11, the signal lines 12, and the ground bare wire 13 are enclosed by the insulating coating 10. The signal lines 12 and the ground bare wire 13 are further enclosed by the metal shield 14. The ground bare wire 13 is in electrical contact with the metal shield 14. As shown in FIG. 5, the metal shield 14 blocks electromagnetic interference from the power lines 11. The interference between the signal lines 12 arranged in pairs can be further reduced for certain, if the signal lines 12 are twisted to form twisted-pair signal lines. The power lines 11 transmit power. The signal lines 12 transmit signals. The metal shield 14 is an aluminum foil element.

The ground terminal 2 is electrically connected to the ground bare wire 13. As mentioned earlier, the ground bare wire 13 is in electrical contact with a metal shield, such that the electromagnetic interference is grounded and guided to the earth. The other terminals 3 are electrically connected to the power lines 11 and the signal lines 12, respectively.

The connector 4 comprises a casing 41 made of plastics, a jack 42, and the ground terminal 2 and plurality of other terminals 3 which are protruded and exposed from the jack 42.

Accordingly, the outdoor control cables in the first and second embodiments of the present invention each comprise the power lines 11 and the signal lines 12 concurrently and thereby transmit power and signals, respectively, thereby dispensing with a conventional control IC and cutting costs. Furthermore, the metal shield 14 blocks electromagnetic interference from the power lines 11. In particular, the ground terminal 2 is directly electrically connected to the metal shield 14. Or, alternatively, the ground terminal 2 is in indirect electrical contact with the metal shield 14 via the ground bare wire 13, such that the electromagnetic interference is grounded and guided to the earth. Preferably, the signal lines 12 arranged in pairs are twisted to form twisted-pair signal lines, such that the interference between the signal lines is further reduced.

Referring to FIG. 6, an outdoor control cable has two connectors according to the present invention. As shown in FIG. 6, the outdoor control cable has one end connected to the connector 4 and the other end connected to another connector 5 opposing the connector 4 in a manner that the connector 4 and the other connector 5 can be connected to each other. The other terminals 3 which belong to the connector 4 and are connected to the power lines 11 and the other terminals 3 which belong to the other connector 5 and are connected to the power lines 11 are electrically coupled together (not shown). The other terminals 3 which belong to the connector 4 and are connected to the signal lines 12 and the other terminals 3 which belong to the other connector 5 and are connected to the signal lines 12 are electrically coupled together (not shown). The ground terminal 2 of the connector 4 and the ground terminal 2 of the other connector 5 are electrically coupled together (not shown).

The above description is directed to preferred embodiments of the present invention only, but is not intended to be restrictive of the claims of the present invention. All equivalent structural changes to the aforesaid preferred embodiments of the present invention based on the contents of the drawings and specification of the present invention should be regarded as a portion of the technical features recited in the claims of the present invention.

What is claimed is:

1. An outdoor control cable, comprising:
a cable comprising an insulating coating, a plurality of power lines each enclosed by an insulating layer, a plurality of signal lines each enclosed by the insulating layer, and a metal shield, wherein the power lines and the signal lines are enclosed by the insulating coating, and the signal lines are further enclosed by the metal shield;
a ground terminal electrically connected to the metal shield;
a plurality of other terminals electrically connected to the power lines and the signal lines, respectively; and
a connector comprising a casing, a jack, and the ground terminal and plurality of other terminals which are protruded and exposed from the jack.

2. The outdoor control cable of claim 1, wherein the metal shield is an aluminum foil element.

3. The outdoor control cable of claim 1, wherein the signal lines are twisted in pairs.

4. An outdoor control cable, comprising:
a cable comprising an insulating coating, a plurality of power lines each enclosed by an insulating layer, a plurality of signal lines each enclosed by the insulating layer, a metal shield, and a ground bare wire, wherein the power lines, the signal lines, and the ground bare wire are enclosed by the insulating coating, wherein the signal lines and the ground bare wire are further enclosed by the metal shield, the ground bare wire being in electrical contact with the metal shield;
a ground terminal electrically connected to the ground bare wire;
a plurality of other terminals electrically connected to the power lines and the signal lines, respectively; and
a connector comprising a casing, a jack, and the ground terminal and plurality of other terminals which are protruded and exposed from the jack.

5. The outdoor control cable of claim 4, wherein the metal shield is an aluminum foil element.

6. The outdoor control cable of claim 4, wherein the signal lines are twisted in pairs.
